(19) United States
(12) Patent Application Publication
(10) Pub. No.: US 2024/0351383 A1
(43) Pub. Date: Oct. 24, 2024

(54) TRAILER ACCESSORY MOUNTING BRACKET ASSEMBLY

(71) Applicant: Lippert Components, Inc., Elkhart, IN (US)

(72) Inventors: Joel D. DILLER, Eau Claire, WI (US); Jesse R. BAUER, Eau Claire, WI (US); Timothy SCHULTZ, Cassopolis, MI (US)

(21) Appl. No.: 18/642,201

(22) Filed: Apr. 22, 2024

Related U.S. Application Data
(60) Provisional application No. 63/460,681, filed on Apr. 20, 2023.

(51) Int. Cl. B60D 1/24

(52) U.S. Cl. CPC B60D 1/247

(57) ABSTRACT

A trailer accessory mounting system includes a holding bracket fixable to a trailer frame and an insert bracket removably securable to the holding bracket. The holding bracket has an outward facing channel and in some embodiments with a downward taper. The insert bracket has inner flanges facing the holding bracket, which may be angled towards each other to engage the downward taper of the outward facing channel of the holding bracket. The insert bracket is securable with an accessory and includes at least one coupler selectively engageable with the holding bracket.

### CROSS-REFERENCES TO RELATED APPLICATIONS

This application claims the benefit of U.S. Provisional Patent Application No. 63/460,681, filed Apr. 20, 2023, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a trailer accessory mounting system and, more particularly, to a trailer accessory mounting system with a connected holding bracket that accommodates a removable and lockable insert bracket, where the insert bracket adjustably secures a trailer accessory.

Referencing spring bars as an exemplary trailer accessory, existing mounting arrangements provide a main bracket for securing the spring bars that is essentially clamped around a trailer beam, and an L-bracket or securement bracket is placed at the correct height in alignment with the main bracket before manually being secured with fasteners. The installation process can be difficult and time-consuming and often requires the installer to get down on the ground.

### SUMMARY

With the trailer accessory mounting system of the described embodiments, the holding or trailer prep bracket is connected (e.g., welded or the like) to the trailer frame and has an outward facing channel and a securement hole near the top. The snap-up/clamp/insert bracket has flanges or a channel facing towards the trailer configured to engage the holding bracket. The insert bracket also includes an aperture near the top and a pin for selectively securing the accessory between the insert and holding brackets when installed.

In some embodiments, the outward facing channel of the holding bracket includes a downward taper, and the insert bracket is configured to engage the downward taper.

The system enables the accessory to be height adjusted relative to the insert bracket prior to connecting the insert bracket to the holding bracket.

In an exemplary embodiment, a trailer accessory mounting system includes a holding bracket fixable to a trailer frame, where the holding bracket has an outward facing channel with a downward taper, and an insert bracket removably securable to the holding bracket. The insert bracket has inner flanges facing the holding bracket. The inner flanges are angled towards each other to engage the downward taper of the outward facing channel of the holding bracket. The insert bracket is securable with an accessory and includes at least one coupler selectively engageable with the holding bracket.

The inner flanges of the insert bracket may define an inward facing channel, and at least one connector selectively engageable with the accessory may be disposed in the inward facing channel. The at least one connector may include at least one post engageable with a corresponding at least one opening in the accessory. The at least one connector may include two posts engageable with corresponding openings in the accessory. The accessory may be an L-bracket for a weight distribution hitch, where the L-bracket includes a plurality of the corresponding openings such that the L-bracket is height adjustable relative to the insert bracket.

The outward facing channel may be non-square in cross-section, and the inner flanges may be correspondingly shaped to define a dovetail connection. The outward facing channel may trapezoid shaped in cross-section.

The holding bracket may include a first securing aperture, and the insert bracket may include a second securing aperture. The coupler may be extendable through the second securing aperture, the accessory, and the first securing aperture. The coupler may include a bolt or a spring-loaded plunger pin connected to the insert bracket.

The holding bracket may include projections on either side of the outward facing channel.

In another exemplary embodiment, a trailer accessory mounting system includes a holding bracket fixable to a trailer frame, where the holding bracket has an outward facing channel, and an insert bracket removably securable to the holding bracket, where the insert bracket has inner flanges facing the holding bracket and engageable with the outward facing channel of the holding bracket. The system also includes an accessory. The insert bracket has at least one connector selectively engageable with the accessory, and the accessory is height adjustable relative to the insert bracket prior to connecting the insert bracket to the holding bracket.

The at least one connector may include a square post engageable with a corresponding square opening in the accessory.

The accessory may include a plurality of openings such that the accessory is selectively adjustable relative to the insert bracket by engaging a selected one of the openings over the post. The accessory may be an L-bracket for a weight distribution hitch.

### BRIEF DESCRIPTION OF THE DRAWINGS

These and other aspects and advantages will be described in detail with reference to the accompanying drawings, in which:

FIG. 1 is a perspective view of a trailer accessory mounting system according to an exemplary embodiment;

FIG. 2 shows the holding bracket of the system fixed to a trailer frame;

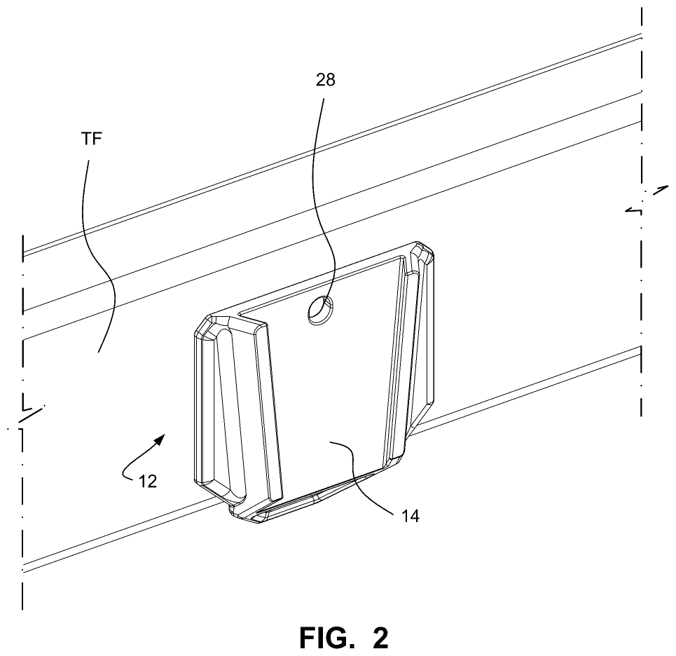

FIG. 3 shows the insert bracket in position to engage the holding bracket;

FIGS. 4 and 5 show details of the holding bracket;

FIGS. 6 and 7 show details of the insert bracket; and

FIG. 8 is a sectional view along a vertical centerline through the system components.

### DETAILED DESCRIPTION

With reference to the drawings, the trailer accessory mounting system 10 of the described embodiments includes a holding bracket 12 fixable to a trailer frame TF. The holding bracket 12 includes an outward facing channel 14. In some embodiments, the outward facing channel 14 is provided with a downward taper as shown. The holding bracket 12 has a flat back intended for welding to the trailer frame TF with the outward facing channel 14 facing away from the trailer frame TF. A welded connection is exemplary, and other connecting methods may be suitable including, for example, a bolt or clamp on mounting for the base. The exemplary tapered geometry of the channels and brackets serve to distribute the downward force over a greater area to make the system stronger as compared to straight channel cuts.

An insert bracket 16 is removably securable to the holding bracket 12. The insert bracket 16 includes inner flanges 18 that are arranged to face the holding bracket 12. In some embodiments, the inner flanges 18 are angled towards each other from top to bottom to engage the downward taper of the outward facing channel 14 of the holding bracket 12.

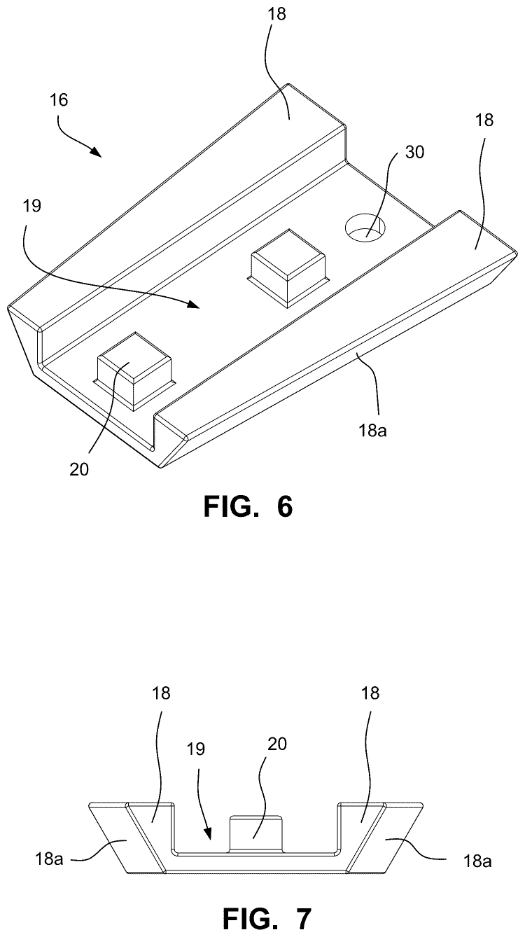

With reference to FIGS. 6 and 7, the inner flanges 18 of the insert bracket 16 may define an inward facing channel 19. The insert bracket 16 may be provided with at least one connector 20 that is selectively engageable with an accessory A. The accessory shown in the drawings is exemplary and alternatively could be any one of many other accessories such as bike racks, steps, flag holders, etc. In other embodiments, the insert bracket 16 may lack an inward facing channel and connectors and would mount the accessory directly.

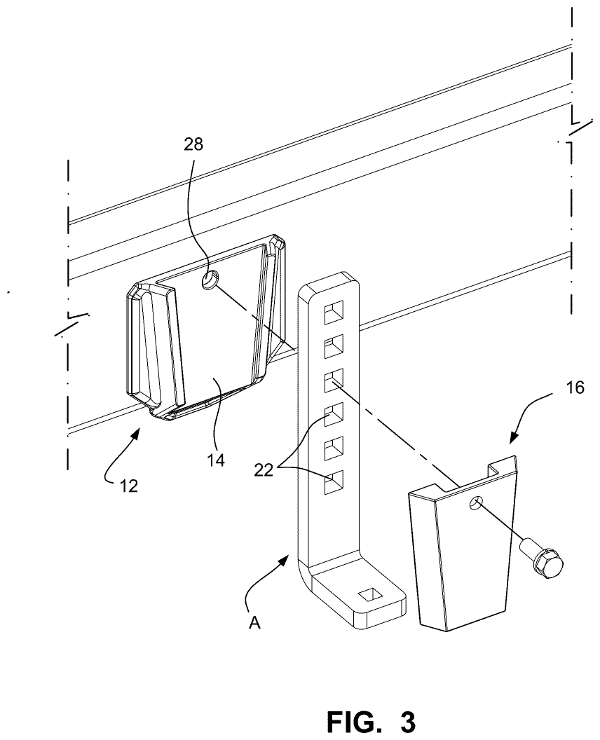

As shown, the at least one connector 20 may be disposed in the inward facing channel 19. In the exemplary embodiment shown in FIGS. 6 and 7, two connectors 20 are shown in the form of square posts. Of course, other shapes may be contemplated, and the invention is not meant to be limited to the embodiment shown in FIGS. 6 and 7. The posts 20 may be selectively engageable with corresponding openings 22 in the accessory A. See FIG. 3.

In some embodiments, the accessory is an L-bracket for a weight distribution hitch. In this context, the L-bracket includes a plurality of the corresponding openings 22 such that the L-bracket is height adjustable relative to the insert bracket 16. That is, the accessory A is height adjustable relative to the insert bracket 16 prior to connecting the insert bracket 16 to the holding bracket 12.

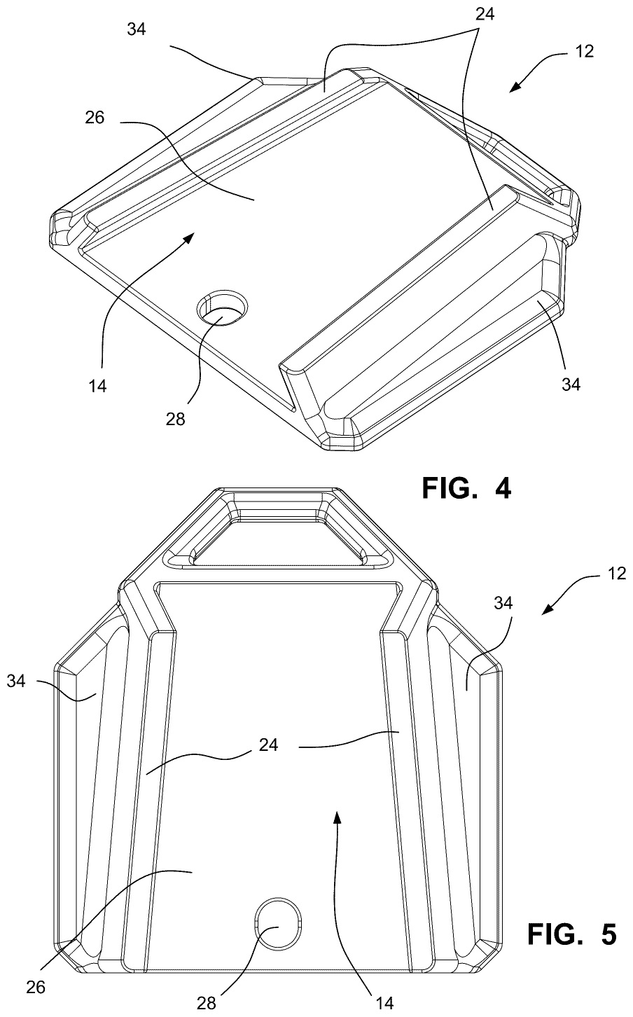

With reference to FIGS. 4 and 5, the outward facing channel 14 is defined by a pair of ridges 24 extending outward from a flat base section 26 of the holding bracket 12. In some embodiments, the ridges 24 extend at an angle less than 90 degrees from the base section 26 such that a cross-section of the outward facing channel is non-square. In the exemplary embodiment shown in FIGS. 4 and 5, the outward facing channel 14 is trapezoid shaped in cross-section. In this context, with continued reference to FIGS. 6 and 7, outer surfaces 18a of the inner flanges 18 may be correspondingly shaped to define a dovetail connection. For example, as shown, the outer surfaces 18a are angled.

The holding bracket 12 may be provided with a first securing aperture 28, and the insert bracket 16 may be provided with a second securing aperture 30. A coupler 32 such as a bolt or a spring-loaded plunger pin is removably extendable through the second securing aperture 30, through one of the openings 22 in the accessory A, and through the first securing aperture 28. In other embodiments, a coupler may extend only through the second securing aperture 30 and through the first securing aperture 28.

The holding bracket 12 may be provided with projections or wings 34 on either side of the outward facing channel 14. The projections 34 provide increased welding surface area for securing the holding bracket 12 to the trailer frame TF. Additionally, the projections 34 may be added for aesthetic purposes.

The holding bracket 12 may optionally include a closed loop 36 with an aperture extending below the channel which may act as an anchor for safety chains when they are not in use.

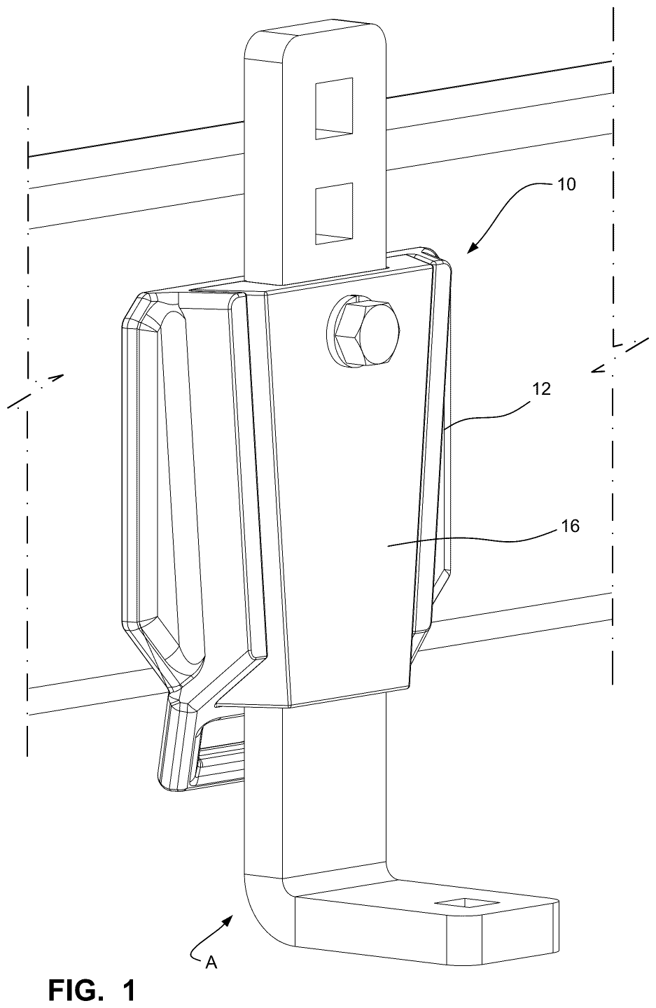

In use, the holding bracket 12 is first connected to the trailer frame TF (e.g., by welding or other suitable connecting means). The accessory A is secured to the insert bracket 16 at a selected relative height adjustment position. Subsequently, the insert bracket 16 and the accessory A are positioned such that the inner flanges 18 of the insert bracket 16 are disposed inside the outward facing channel 14. The insert bracket 16 is lowered into engagement with the holding bracket 12 to secure the accessory A (see FIG. 1).

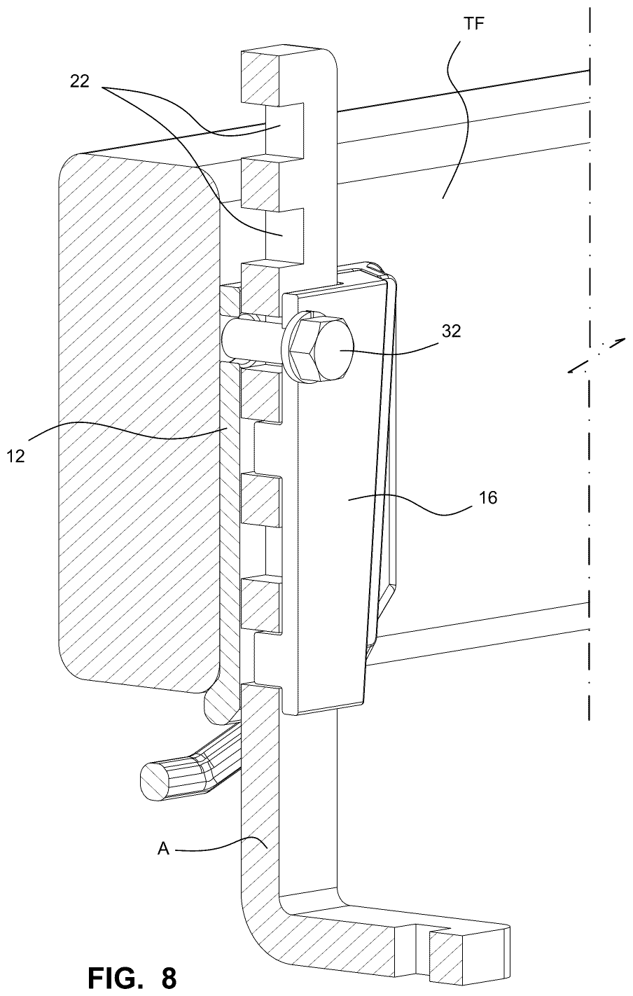

FIG. 8 is a cross-sectional view through a longitudinal centerline of the system components showing the insert bracket 16 fully seated in the holding bracket 12 with the accessory A connected and sandwiched between them. The pin 32 extends through respective apertures of the insert bracket 16, the accessory A, and the holding bracket 12 and may abut the trailer frame TF to provide clearance for the fastener and prevent it from lifting or falling out. The use of a spring-loaded plunger pin for the pin 32 provides for a tool-free installation system.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A trailer accessory mounting system comprising:
a holding bracket fixable to a trailer frame, the holding bracket including an outward facing channel with a downward taper; and
an insert bracket removably securable to the holding bracket, the insert bracket including inner flanges facing the holding bracket, wherein the inner flanges are angled towards each other to engage the downward taper of the outward facing channel of the holding bracket,
wherein the insert bracket is securable with an accessory and includes at least one coupler selectively engageable with the holding bracket.

2. A trailer accessory mounting system according to claim 1, wherein the inner flanges of the insert bracket define an inward facing channel, and wherein at least one connector selectively engageable with the accessory is disposed in the inward facing channel.

3. A trailer accessory mounting system according to claim 2, wherein the at least one connector comprises at least one post engageable with a corresponding at least one opening in the accessory.

4. A trailer accessory mounting system according to claim 3, wherein the at least one connector comprises two posts engageable with corresponding openings in the accessory.

5. A trailer accessory mounting system according to claim 4, further comprising the accessory, wherein the accessory is an L-bracket for a weight distribution hitch, the L-bracket comprising a plurality of the corresponding openings such that the L-bracket is height adjustable relative to the insert bracket.

6. A trailer accessory mounting system according to claim 1, wherein the outward facing channel is non-square in cross-section, and wherein the inner flanges are correspondingly shaped to define a dovetail connection.

7. A trailer accessory mounting system according to claim 6, wherein the outward facing channel is trapezoid shaped in cross-section.

8. A trailer accessory mounting system according to claim 1, wherein the holding bracket comprises a first securing aperture, and wherein the insert bracket comprises a second securing aperture, wherein the coupler is extendable through the second securing aperture, the accessory, and the first securing aperture.

9. A trailer accessory mounting system according to claim 8, wherein the coupler comprises a bolt or a spring-loaded plunger pin connected to the insert bracket.

10. A trailer accessory mounting system according to claim 1, wherein the holding bracket comprises projections on either side of the outward facing channel.

11. A trailer accessory mounting system comprising:
a holding bracket fixable to a trailer frame, the holding bracket including an outward facing channel;
an insert bracket removably securable to the holding bracket, the insert bracket including inner flanges facing the holding bracket and engageable with the outward facing channel of the holding bracket; and
an accessory,
wherein the insert bracket includes at least one connector selectively engageable with the accessory, and wherein the accessory is height adjustable relative to the insert bracket prior to connecting the insert bracket to the holding bracket.

12. A trailer accessory mounting system according to claim 11, wherein the outward facing channel of the holding bracket comprises a downward taper, and wherein the inner flanges of the insert bracket are angled towards each other to engage the downward taper of the outward facing channel.

13. A trailer accessory mounting system according to claim 11, wherein the inner flanges of the insert bracket define an inward facing channel, and wherein the at least one connector comprises a post disposed in the inward facing channel.

14. A trailer accessory mounting system according to claim 13, wherein the at least one connector comprises a square post engageable with a corresponding square opening in the accessory.

15. A trailer accessory mounting system according to claim 13, wherein the accessory comprises a plurality of openings such that the accessory is selectively adjustable relative to the insert bracket by engaging a selected one of the openings over the post.

16. A trailer accessory mounting system according to claim 15, wherein the accessory is an L-bracket for a weight distribution hitch.
